(19) United States
(12) Patent Application Publication
(10) Pub. No.: US 2008/0276908 A1
(43) Pub. Date: Nov. 13, 2008

(54) Throttle apparatus having electronic control means built-in

(75) Inventor: Tsutomu Murakami, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi-shi (JP)

(21) Appl. No.: 12/000,367

(22) Filed: Dec. 12, 2007

(30) Foreign Application Priority Data
May 9, 2007 (JP) 2007-124748

(51) Int. Cl. F02D 41/00

(52) U.S. Cl. 123/478; 701/103

(57) ABSTRACT

The present invention provides a throttle apparatus having an electronic control means built-in which uses an engine fuel supply system having a carburetor specification and is arranged for constructing a fuel injection system in accordance with an electronic control.

### BACKGROUND OF THE INVENTION

1. Field of the Invention

The present invention relates to a throttle apparatus having an electronic control means built-in, and more particularly to a throttle apparatus having an electronic control means built-in which uses an engine fuel supply system having a carburetor specification and is arranged for constructing a fuel injection system in accordance with an electronic control.

2. Description of Related Art

In an engine system in which a simple structure and a low cost are demanded, such as a general purpose engine or the like, it is general to suck a fuel to intake passages 15 and 16 by a carburetor 2 having a structure as shown in FIG. 4 so as to supply to the engine. In the case of modifying or changing the engine fuel supply system having the carburetor specification as mentioned above to a fuel injection system in accordance with an electronic control, it is necessary to add a throttle body, an injector, a fuel pressure regulator, a fuel gallery, and an electronic control unit serving as a fuel injection control means to the existing fuel supply system, and further arrange sensors such as a pressure sensor, a temperature sensor and the like for inputting a data such as an engine operational state or the like to the electronic control unit.

Accordingly, a lot of labor hour for attaching a lot of parts is necessary for changing the system, thereby constituting one factor for preventing the fuel supply system from being formed as the electronic control unit. Further, in the engine system having the carburetor specification, it is often the case that a space for arranging the engine of the mounted type has a small margin, and it is further often the case that it is hard in design to secure a space for adding and arranging a new part.

With regard to this problem, a throttle apparatus (an intake apparatus) having an electronic control means obtained by integrating an injector and an electronic control means with a throttle apparatus regulating an intake air amount built-in is proposed in Japanese Unexamined Patent Publication No. 2001-73828 and Japanese Unexamined Patent Publication No. 2001-263128. As mentioned above, since three main parts are brought together by incorporating the injector and the electronic control means within the throttle body, it is possible to largely reduce a labor hour for modifying to the fuel injection system in accordance with the electronic control.

However, in the case of only attaching the throttle apparatus having the electronic control means obtained by compactly bringing these three main parts together to the arranged position of the carburetor, there is left a labor hour for arranging sensors for inputting various data to the electronic control means at predetermined positions. Further, in order to arrange the sensors in the system, it is necessary to set an outer portion connecting connector for inputting an output signal wiring to the electronic control means in an outer surface of a throttle body so as to connect. However, since a protruding direction of the connector is previously determined, it tends to be further hard to change the system in the case that the arranging space around the engine is small.

Further, there is additionally demanded a labor hour for newly attaching a fuel pressure regulator capable of discharging the fuel even in the case that the fuel is vaporized within the fuel supply pipe by regulating a pressure of the fuel supplied to the engine, and a space for arranging the fuel pressure regulator. Accordingly, there is desired a means which can easily achieve a change of the fuel supply system while minimizing the space demanded for adding the parts.

### SUMMARY OF THE INVENTION

The present invention aims to solve the problem mentioned above, and an object of the present invention is to minimize a new arranging space and a labor hour for work in accordance with a system change, in the case of constructing a fuel injection system in accordance with an electronic control by using an engine fuel supply system having a carburetor specification.

In accordance with the present invention achieved for solving the problem mentioned above, there is provided a throttle apparatus having an electronic control means which is arranged in a fuel injection system of an engine and executes at least a fuel injection control built-in, comprising:

an injector to which a fuel passage is connected and which is driven and controlled by the electronic control means so as to inject a fuel within an intake passage passing through a throttle body; and

at least one kind of sensor detecting a predetermined data used for a fuel injection control so as to output to the electronic control means,

wherein the injector and at least one kind of sensor are provided at predetermined positions of the throttle body so as to construct one apparatus.

As mentioned above, since the injector and the predetermined sensor are provided in the throttle body so as to be brought together into one apparatus in addition to incorporating the electronic control means in the throttle body, for example, in the case of modifying the fuel supply system having the carburetor specification to the fuel injection control system in accordance with the electronic control, an arrangement of most of the main parts constituting the system is completed only by arranging the fuel injection control system in place of the carburetor, and it is possible to construct a new system while minimizing a new arranging space demanded for additionally installing the part.

Further, if the throttle apparatus having the electronic control means built-in is structured such as to be provided with a structure of a connecting portion and a whole shape capable of being attached to a predetermined position of an intake pipe line in which a carburetor of a fuel supply system having a carburetor specification is arranged, it is extremely easy to carry out a work for changing to the fuel injection system in accordance with the electronic control.

Further, in the throttle apparatus having the electronic control means mentioned above built-in, in the case that at least one of a temperature sensor and a pressure sensor is included in the sensor provided in the throttle body, it is possible to large reduce a labor hour for arranging the sensors for outputting the data relating to the engine operational state to the electronic control means in the system and a labor hour for connecting the output wiring to the electronic control means.

Further, in the throttle apparatus having the electronic control means mentioned above, if the structure is made such that a fuel pressure regulator for regulating a fuel injection pressure to a predetermined pressure is provided at a predetermined position of the throttle body, it is possible to further easily construct the fuel injection system in accordance with the electronic control without demanding a labor hour for additionally arranging the fuel pressure regulator.

In accordance with the present invention in which the injector and the predetermined sensor are provided in the throttle apparatus having the electronic control means built-in, a plurality of main parts constructing the system are brought together into one apparatus, and it is possible to minimize the new arranging space in accordance with the system change and the labor hour for the work.

### BRIEF DESCRIPTION OF THE DRAWINGS

FIG. 1 is a front elevational view showing an embodiment in accordance with the present invention;

FIG. 2 is a cross sectional view along a line X-X in FIG. 1;

FIG. 3 is a cross sectional view along a line Y-Y in FIG. 2; and

FIG. 4 is a front elevational view of a carburetor arranged in a fuel supply system having a carburetor specification.

### DESCRIPTION OF PREFERRED EMBODIMENTS

A description will be given of a best mode for carrying out the present invention with reference to the accompanying drawings.

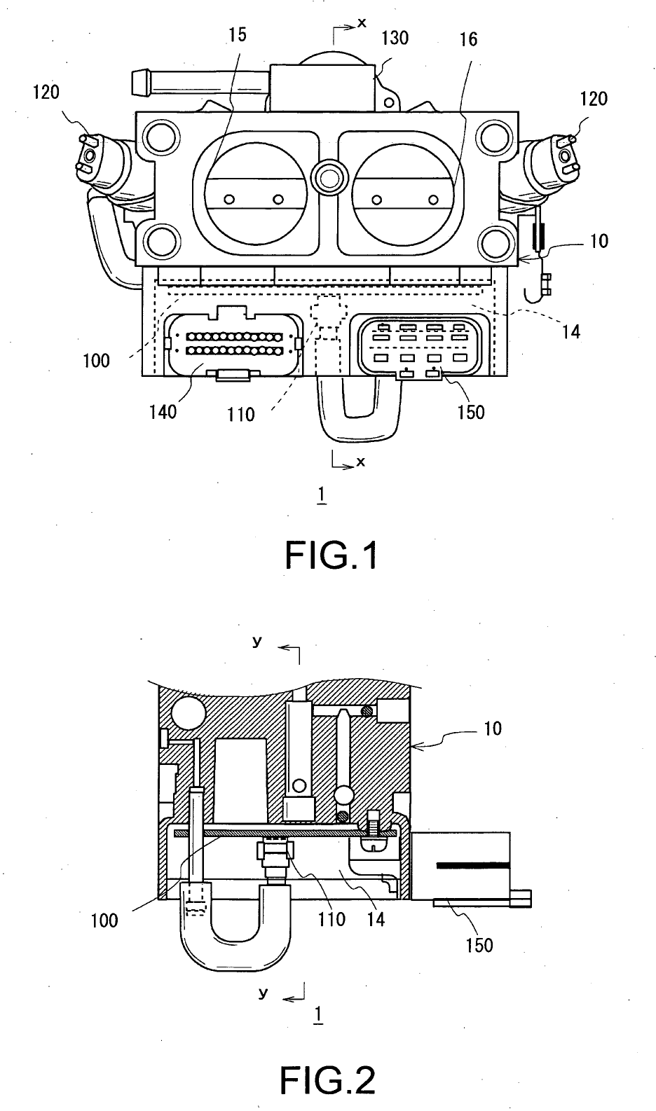

FIGS. 1 to 3 show a throttle apparatus 1 having an electronic control means corresponding to an embodiment in the present invention built-in. The throttle apparatus 1 having the electronic control means built-in is provided on the assumption of being arranged as it is in place of the carburetor at the arranged position of the carburetor in the system, in the case of constructing the fuel injection system in accordance with the electronic control by using the fuel supply system of the general purpose engine having the carburetor specification. The throttle apparatus 1 is provided with an electronic control unit (ECU) 100 serving as the electronic control means within a throttle body 10, and is additionally provided with injectors 120 and 120, a pressure sensor 110 detecting an intake pressure and a fuel pressure regulator 130 integrally so as to construct one apparatus.

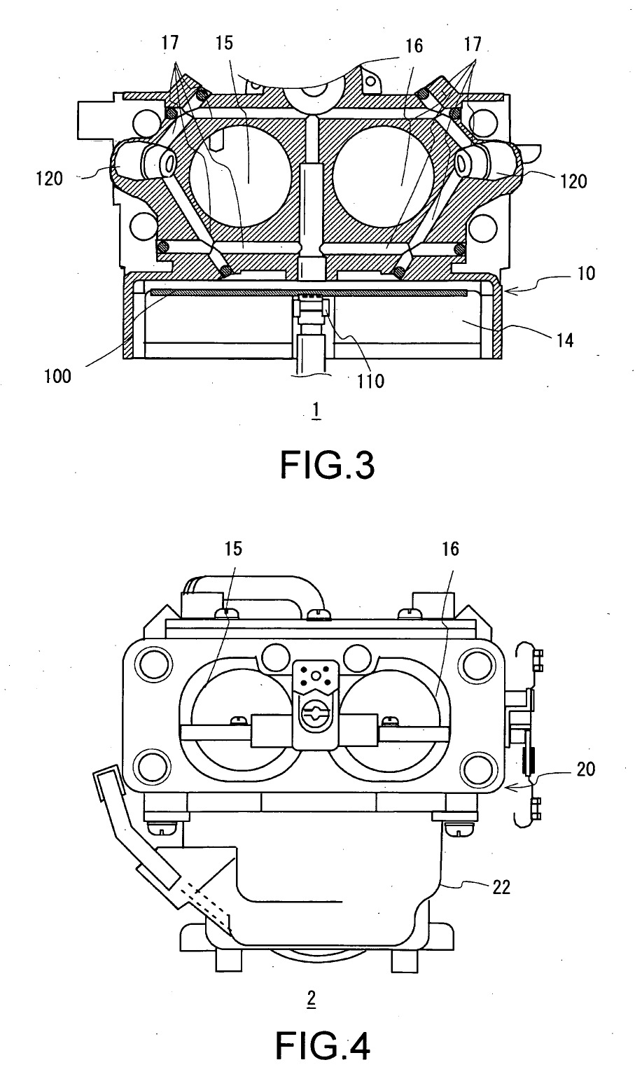

FIG. 1 is a front elevational view in the present embodiment. The throttle apparatus 1 having the electronic control means built-in is formed approximately the same size as that of the carburetor 4 shown in FIG. 4, and a shape and a magnitude of a space demanded for arranging it are approximately the same. Further, positions and shapes of bolt holes in both end surface sides coupled to an intake pipe side in the fuel supply system and open ends of intake passages 15 and 16 are in common. Accordingly, it is possible to easily attach the throttle apparatus 1 having the electronic control means in accordance with the present embodiment built-in as it is to the position to which the carburetor 2 is attached.

FIG. 2 is a cross sectional view along a line X-X in FIG. 1. The throttle apparatus 1 having the electronic control means built-in is provided with an ECU chamber 14 having the same volume as a float chamber 22 in a lower portion of the throttle apparatus 1, that is, in a corresponding portion to the float chamber 22 of the carburetor 2 shown in FIG. 4, and the electronic control unit 100 is accommodated in an inner portion thereof. Further, connectors 140 and 150 for connecting input and output wirings between the electronic control unit 100 and an outer portion are arranged in a side portion thereof. In this case, the electronic control unit 100 may be constituted by an electronic substrate, and may have the other programs for controlling the vehicle in addition to the general fuel injection control program in a memory means so as to have a function of executing the program.

The connectors 140 and 150 in which connection portions are exposed to an outer surface of the throttle body 10 are structured such as to connect an output wiring for supplying an electric power to the electronic control unit 100 and the sensors, inputting output signals from the sensors detecting data of an engine operational state which can not be detected at this position, such as an engine rotating speed and the like, or transmitting an output signal of the electronic control unit 100 to an actuator, a display means or the like arranged at a different position from the throttle body 10.

In the present embodiment, since the ECU chamber 14 and the connectors 140 and 150 for connecting to the outer portion which demand the comparatively large space are arranged at the position of the float chamber 22 of the carburetor 2 in a state of occupying approximately the same level of space, it is not necessary to set a new arranging space for additionally installing the parts demanded for constructing the fuel injection control system, and the new system can be constructed even in the case that the arranging space around the engine has no margin.

Further, the throttle apparatus 1 having the electronic control means built-in is structured such that in addition that the throttle body 10 provided with the throttle valve for regulating the intake air amount has the electronic control unit 100 serving as the electronic control means built-in, the injectors 120 and 120 are provided so as to expose an injection port side to the intake passages 15 and 16 as well as a fuel passage 17 passing through a wall body of the throttle body 10 is connected thereto, and the throttle body 10 is provided with sensors such as a pressure sensor 110 detecting a predetermined data indicating an engine operation state so as to output to the electronic control unit 100.

In the present embodiment, the structure is made such as to be provided with a temperature sensor (not shown) detecting a temperature of an intake air in addition to the pressure sensor 110 so as to use a detected data for controlling the fuel injection of the electronic control unit 100. In this case, as the other data relating to the engine operational state which can be detected at the position of the throttle apparatus, there can be listed up a throttle opening degree, a fuel pressure, a fuel temperature and the like, and sensors detecting them may be provided in the throttle body 10 as occasion demands.

Further, a fuel pressure regulator 130 for regulating the fuel injection pressure to a predetermined pressure is provided in an upper surface side of the throttle body 10 so as to connect an operating position thereof to the fuel passage 17 side. Accordingly, it is possible to make the fuel pressure low, and it is possible to construct the system by using a plunger reciprocating type fuel pump used in the fuel supply system having the carburetor specification as it is. In this case, the fuel passage 17 passing through an inner portion of the throttle body 10 is assumed to have an arrangement as shown in FIG. 3 corresponding to a cross sectional view along a line Y-Y in FIG. 2, however, the fuel pressure regulator 130 may be connected to a position which is not far from the injectors 120 and 120.

Further, the intake temperature sensor (not shown) detecting the temperature of the intake air is arranged at the predetermined position of the throttle body 10 so as to connect the detecting portion to the intake passages 15 and 16 as mentioned above, and the detected intake temperature data is output to the electronic control unit 100 so as to be used for controlling the fuel injection.

Since the throttle apparatus 1 having the electronic control means built-in is structured as mentioned above, it is possible to simultaneously attach the throttle apparatus, the injector, the electronic control apparatus, the various sensors for detecting the engine operational state, and the fuel pressure regulator which correspond to the main parts of the system, only by attaching the throttle apparatus 1 having the electronic control means built-in to the arranged position of the carburetor 2, in the case of constructing or modifying the fuel injection control system in accordance with the electronic control by utilizing the engine fuel supply system having the carburetor specification. Accordingly, since the system is approximately finished only by this attachment, a labor hour demanded for changing the system can be minimized.

In this case, the description is given above of the case that the fuel injection system in accordance with the electronic control is constructed by using the engine fuel supply system having the carburetor specification, however, it goes without saying that the fuel injection system may be manufactured from a stage of designing the system. Even in this case, since the main parts constructing the system are brought together into one apparatus, the labor hour of the work in the system construction can be reduced, and the arranging space newly demanded in accordance with the additional provision of the parts is minimized. Accordingly, a freedom of design is increased.

As mentioned above, in the case of constructing the fuel injection system in accordance with the electronic control by using the engine fuel supply system having the carburetor specification, it is possible to minimize the arranging space for additionally installing the parts and the labor hour for the work on the basis of the present invention, and the system change can be easily carried out.

1. A throttle apparatus having an electronic control means which is arranged in a fuel injection system of an engine and executes at least a fuel injection control built-in, comprising:
an injector which is driven and controlled by the electronic control means so as to inject a fuel from a fuel passage within an intake passage passing through a throttle body; and
at least one kind of sensor detecting a predetermined data used for a fuel injection control so as to output to the electronic control means,
wherein the injector and at least one kind of sensor are provided at predetermined positions of the throttle body so as to construct one apparatus.

2. A throttle apparatus having an electronic control means built-in as claimed in claim 1, wherein the throttle apparatus is provided with a structure of a connecting portion and a whole shape capable of being attached to a predetermined position of an intake pipe line in which a carburetor of a fuel supply system having a carburetor specification is arranged.

3. A throttle apparatus having an electronic control means built-in as claimed in claim 1, wherein at least one of a temperature sensor and a pressure sensor is included in the sensor provided in the throttle body.

4. A throttle apparatus having an electronic control means built-in as claimed in claim 2, wherein at least one of a temperature sensor and a pressure sensor is included in the sensor provided in the throttle body.

5. A throttle apparatus having an electronic control means built-in as claimed in claim 1, wherein a fuel pressure regulator for regulating a fuel injection pressure to a predetermined pressure is provided at a predetermined position of the throttle body.

6. A throttle apparatus having an electronic control means built-in as claimed in claim 2, wherein a fuel pressure regulator for regulating a fuel injection pressure to a predetermined pressure is provided at a predetermined position of the throttle body.

7. A throttle apparatus having an electronic control means built-in as claimed in claim 3, wherein a fuel pressure regulator for regulating a fuel injection pressure to a predetermined pressure is provided at a predetermined position of the throttle body.

8. A throttle apparatus having an electronic control means built-in as claimed in claim 4, wherein a fuel pressure regulator for regulating a fuel injection pressure to a predetermined pressure is provided at a predetermined position of the throttle body.
